(19) United States
(12) Patent Application Publication
(10) Pub. No.: US 2007/0047917 A1
(43) Pub. Date: Mar. 1, 2007

(54) Apparatus and method for playing summarized video

(76) Inventors: Akira Sasaki, Yokohama (JP); Norikazu Sasaki, Ebina (JP); Kazunori Iwabuchi, Yokohama (JP)

Correspondence Address: MCDERMOTT WILL & EMERY LLP, 600 13TH STREET, N.W., WASHINGTON, DC, 20005-3096, US

(21) Appl. No.: 11/509,058

(22) Filed: Aug. 24, 2006

(30) Foreign Application Priority Data
Aug. 30, 2005 (JP) 2005-248575

(51) Int. Cl. H04N 7/00

(52) U.S. Cl. 386/96

(57) ABSTRACT

An apparatus is provided that easily realizes a video recording and playback according to a taste of the user based on summary information prepared from voice/video information of TV broadcast programs. For this purpose, a seek bar is provided which, based on the summary playback information generated by the summary information generation unit for summary playback, distinguishes the time bands to be played back from the time bands to be skipped by displaying them in different colors. Also a control unit is provided which allows for changing the summary playback time and for selecting between the playback enable and disable.

### INCORPORATION BY REFERENCE

The present application claims priority from Japanese application JP2005-248575 filed on Aug. 30, 2005, the content of which is hereby incorporated by reference into this application.

### BACKGROUND OF THE INVENTION

1. Field of the Invention

The present invention relates to a recording and playback apparatus for recording and playing back video and audio information and more particularly a recording and playback apparatus capable of playing a summarized video.

2. Description of the Related Art

A recording and playback system, such as a video recording apparatus disclosed in JP-A-2002-330390, exists that uses voice volume information in a recorded video file to extract information representing only important scenes to perform a so-called highlight playback.

### SUMMARY OF THE INVENTION

With this technology, it is possible to extract information representing only important scenes in a long program and thereby play a recorded video file in a short time.

However, since the portion of the recorded video that is summarized for playback is selected mechanically, the summary is not necessarily made in accordance with a preference of the user. For example, in a music and entertainment program composed of a music part and a talk part, since the summary is made centered around the music part, music that does not match the taste of the user may be played or a talk part showing a favorite talent may fail to be played, making it impossible to prepare the summary according to the preference of the user.

In a recording and playback system with a summary playback mechanism, the present invention provides the user with a method for communicating to the user in an easily understandable way information indicating which area is to be played or skipped and also with a recording and playback apparatus having a playback control method for easily performing the playback according to the taste of the user.

The present invention solves the above problem by providing a display means called a seek bar showing a summary playback state on a display device that performs the summary playback and a control means for the user to operate the seek bar.

Since this invention displays distinctively an area to be played summarized and an area not to be played during the summary playback, the user can recognize beforehand which areas in the entire program are to be played.

Further, since, during the summary playback, the user can easily change a time duration of the summary playback or summary ratio or whether a portion of interest is to be played or not to be played, it is possible to realize the summary playback that matches the preference of the user.

### BRIEF DESCRIPTION OF THE DRAWINGS

FIG. 1 is an internal block diagram of a recording and playback system.

FIG. 2 illustrates a recorded video file and a summary importance level information in a storage device.

FIG. 3 illustrates summary importance level information.

FIG. 4 illustrates an external view of a remote.

FIG. 5 illustrates an example of summary playback information in an embodiment.

FIGS. 6A-6D are schematic views showing a summary playback screen and a seek bar.

FIGS. 7A-7B are schematic views showing how the summary playback ratio is changed during the summary playback.

FIG. 8 illustrates an example of summary playback information in an embodiment.

FIG. 9 is a schematic view showing a summary playback screen and a seek bar in an embodiment.

FIG. 10 is a diagram showing a sequence for displaying one frame during the summary playback.

FIG. 11 is a diagram showing a sequence for displaying one frame during the summary playback.

### DESCRIPTION OF THE EMBODIMENTS

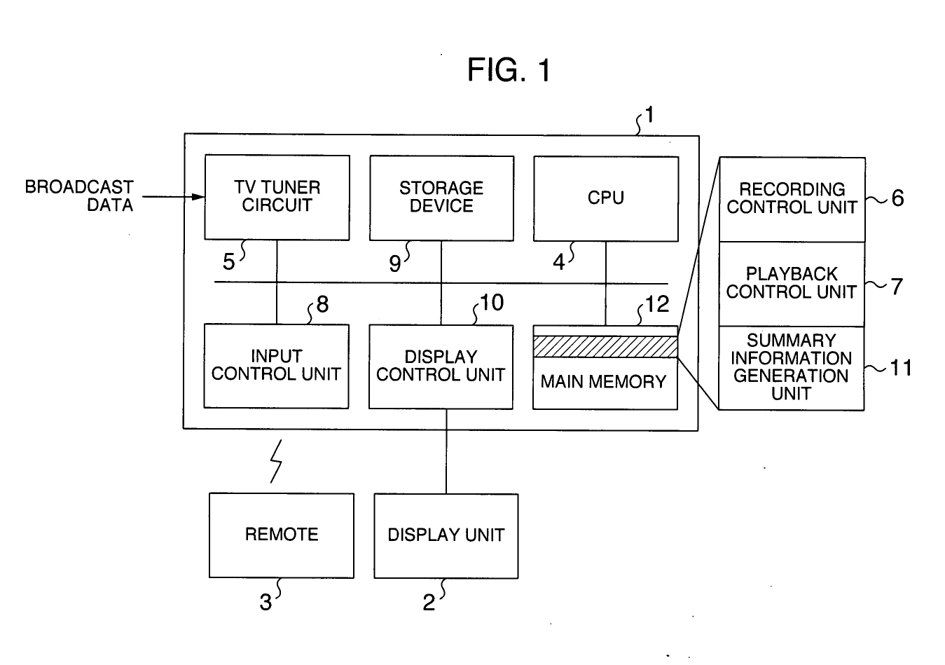

Embodiments of the present invention will be described by referring to the accompanying drawings. FIG. 1 shows a configuration of a recording and playback system as one embodiment of this invention.

The recording and playback system 1 comprises a remote 3 to set a receiving channel of the recording and playback system 1 and enter program reservation information, a CPU 4 and main memory 12 to control a video recording device, a TV tuner circuit 5 to receive broadcast data, an input control unit 8 to enter an operation command and information into the recording and playback system, a storage device 9 to record video/voice information and programs, and a display control unit 10 to perform control to display on a display unit 2 the video/voice information received by the TV tuner circuit 5 and the video/voice information recorded in the storage device 9.

The control program of the video recording device executed by the CPU 4 is mapped in the main memory 12 and comprises a recording control unit 6 to record video/voice information of the broadcast programs into the storage device, a playback control unit 7 to play the video/voice information recorded in the storage device, and a summary information generation unit 11 to generate summary playback information from the video/voice information of the video file recorded in the storage device.

The above configuration is just one example of the recording and playback system applying the present invention which is not limited to this example but may have any configuration as long as it can perform the following functions.

In FIG. 1, when a record command is sent from the remote 3 to the input control unit 8, the recording and playback system 1 records the video information such as broadcast programs received from the TV tuner circuit 5 in the storage device 9.

The summary information generation unit 11 generates summary importance level information, the source of the summary playback information, from the video/voice information in the video file recorded in the storage device 9 and records it in the storage device 9.

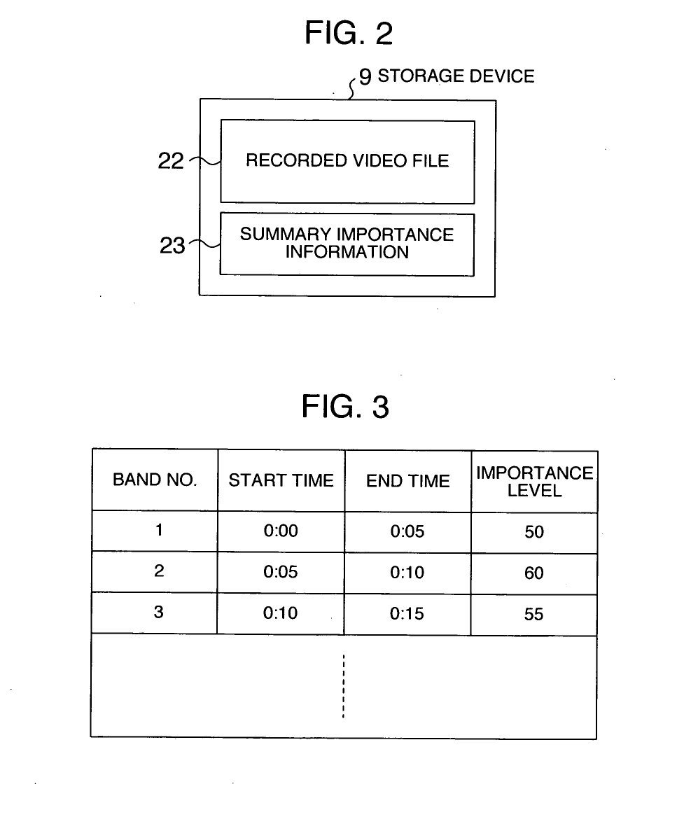

FIG. 2 shows information recorded in the storage device. Denoted 22 is a recorded video file and 23 summary importance level information. As shown in FIG. 2, the summary importance level information 23 is recorded paired with the recorded video file 22.

FIG. 3 shows a part of a table representing the summary importance level information. As shown in FIG. 3, the summary importance level information includes, for each time band, a start time and an end time and a value representing an importance level of the entire recorded video file of that time band.

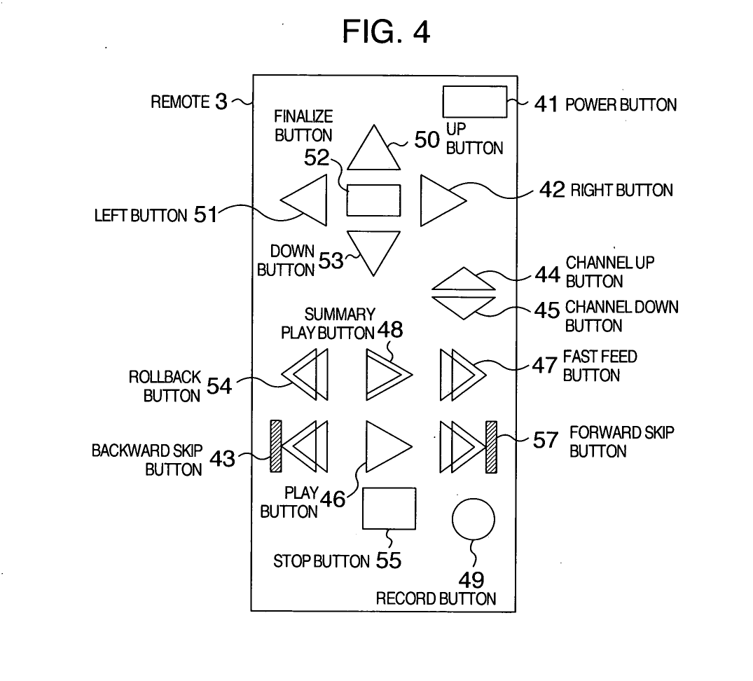

FIG. 4 shows a schematic view of the remote 3 to operate the recording and playback system 1. Denoted 41 is a power button, 42 a right button, 43 a backward skip button, 44 a channel up button, 45 a channel down button, 46 a play button, 47 a fast feed button, 48 a summary play button, 49 a record button, 50 an up button, 51, a left button, 52 a finalize button, 53 a down button, 54 a rollback button, and 57 a forward skip button.

Pressing the summary play button 48 of the remote 3 causes a summary playback command to be sent from the remote 3 to the input control unit 8. The summary information generation unit 11 then reads the summary importance level information 23 recorded in the storage device 9 and decides whether or not to play portions of the recorded video, beginning with the one with a highest importance level, to generate the summary playback information so that the summarized video will have the set summary playback duration.

The method of generating the summary importance level information is not described here because it is outside the scope of this invention.

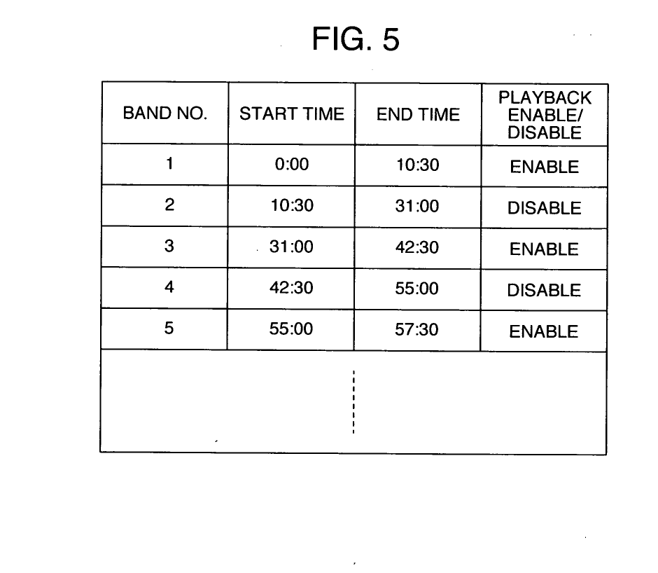

FIG. 5 shows a part of an example summary playback information. As shown in FIG. 5, the summary playback information describes start and end time information and information about whether or not a portion of the recorded video in each time band is to be played.

During the summary playback, the playback control unit 7 based on the summary playback information starts playing the video/voice information in the video file 22 recorded in the storage device 9. At this time, for a time band for which the playback is enabled, the corresponding portion of the summary playback information is played. For a time band for which the playback is disabled, the corresponding portion of the summary playback information is not played. The playback control unit 7 then skips to a time band where the playback is enabled.

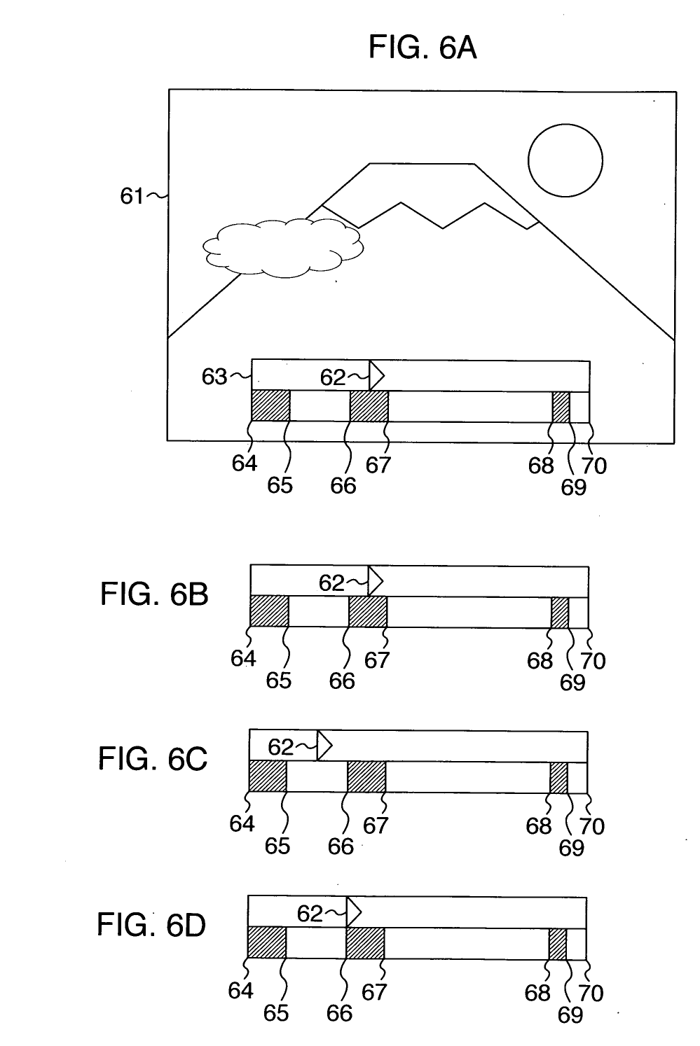

FIG. 6A shows a screen during the summary playback. Denoted 61 is an entire playback screen, 63 a seek bar, 62 a cursor representing a position where the playback is currently underway, 64 a playback start position, 65 to 69 markers, and 70 a playback end position.

During the summary playback, as shown in FIG. 6A, the seek bar 63 is displayed on the playback screen 61 of the display unit 2 based on the information described in the summary playback information. Alternatively, the seek bar 63 may be displayed when a playback control operation is received from the user and, a predetermined time later, erased.

The time bands or areas where the playback is performed, i.e., between 64 and 65, between 66 and 67 and between 68 and 69, are displayed in a bright color and the time bands where the playback is not performed, i.e., between 65 and 66, between 67 and 68 and between 69 and 70, are displayed in a dark color. The user therefore can easily identify which time bands in the recorded video file 22 are to be played. Although in this example, a bright color and a dark color are used, different colors or different patterns may be used if these areas can be made easily distinguishable.

The summary play button 48 is a button to select between the summary playback and the normal playback. If the summary play button 48 is pressed during the summary playback, the summary playback is switched to the normal playback. The seek bar 63 with the summary play button 48 depressed in the state of FIG. 6A is shown in FIG. 6B. As shown in FIG. 6B, the whole time band of the seek bar 63 is displayed in a bright color with markers left as is. Since the control during the normal playback becomes available, the images skipped during the summary playback can be viewed easily by pressing the backward skip button 43, as required, to move back to the previous marker or by pressing the rollback button 54 for rollback. FIG. 6C shows the seek bar 63 and the cursor 62 when the recorded video is a little rolled back.

Pressing the summary play button 48 during the normal playback changes the mode to the summary playback. FIG. 6D shows the seek bar 63 and the cursor 62 when the summary play button 48 is pressed in the state of FIG. 6C. If the cursor 62 prior to the depression of the summary play button 48 is situated in the time band that is not played during the summary playback, the change to the summary playback causes the cursor 62 to skip to the next time band to be played.

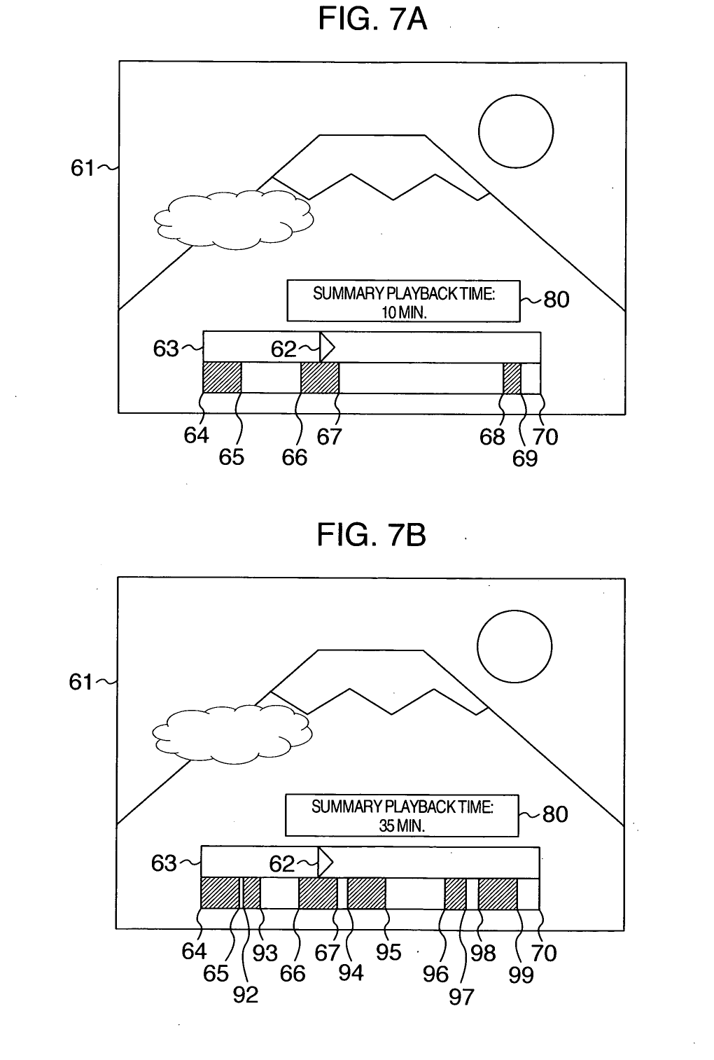

FIG. 7 explains how the summary playback time during the summary playback is changed. FIG. 7A represents a screen prior to the change and FIG. 7B represents a screen after the change.

When the user presses the up button 50 or down button 53 of the remote 3 during the summary playback, the summary playback time 80 is displayed on the playback screen 61, as shown in FIG. 7A, and erased a predetermined time later. Alternatively, it may be displayed along with the seek bar 63. Or, a summary playback ratio may be displayed instead of the summary playback time. The summary playback ratio is a percentage of the summary playback time length with respect to the time length of the video/voice information recorded in the video file.

As shown in FIG. 7B, pressing the up button 50 causes the summary playback time 80 on the playback screen 61 to increase and pressing the down button 53 reduces the displayed summary playback time 80. The summary information generation unit 11 generates new summary playback information corresponding to the summary playback time from the summary importance level information 23. The newly generated summary playback information is used to update the seek bar 63 on the display unit.

In FIG. 7B, since the summary playback time has increased, time bars between 92 and 93, between 94 and 95 and between 96 and 97 are added to the seek bar 63, with the band between 68 and 69 expanding into an area between 98 and 99.

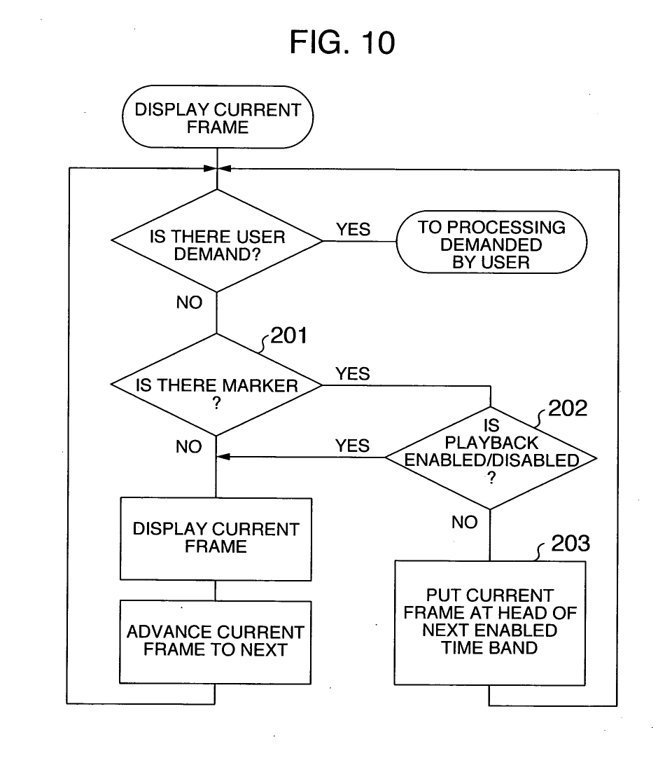

FIG. 10 shows an outline of the processing to display one frame during the summary playback. If there is no user demand and the marker that is set based on the summary playback information is not set in a current frame (the screen about to be displayed), the current frame is first displayed and then updated to display one frame after another. If there is a user demand, the processing moves to a routine that conforms to the user demand. If the marker that is set according to the summary playback information is set in the current frame, the summary playback information for the current time band is referenced. If the playback enable/disable selection is set to enable, the current frame is displayed and then updated. If the playback enable/disable selection is set to disable, the summary playback information is referenced and the current frame is advanced to the head of the time band whose playback enable/disable selection is set to enable.

During the normal playback, since the decisions 201, 202 and the processing 203 associated with the marker and the summary playback information are not executed, the entire frame is displayed.

Though not shown in FIG. 10 for the sake of simplicity, if there is no remaining time band for playback, the display processing is ended.

When the summary play button 48 on the remote 3 is pressed or when the up button 50 or down button 53 is pressed, the summary playback and the normal playback are switched according to the routine processing demanded by the user or the summary playback ratio is changed to generate new summary playback information.

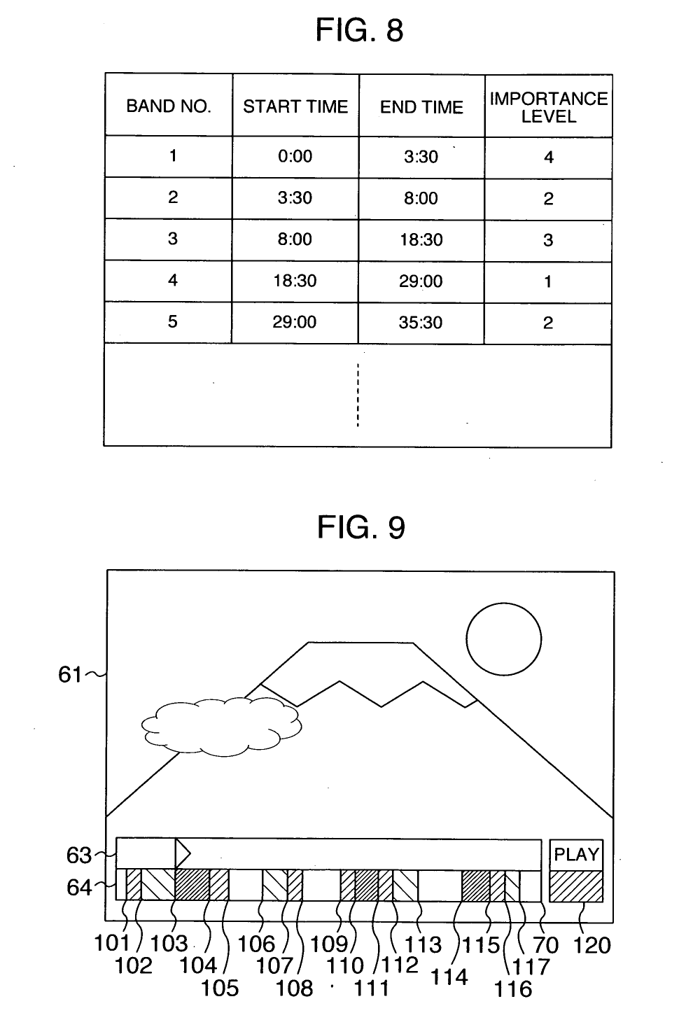

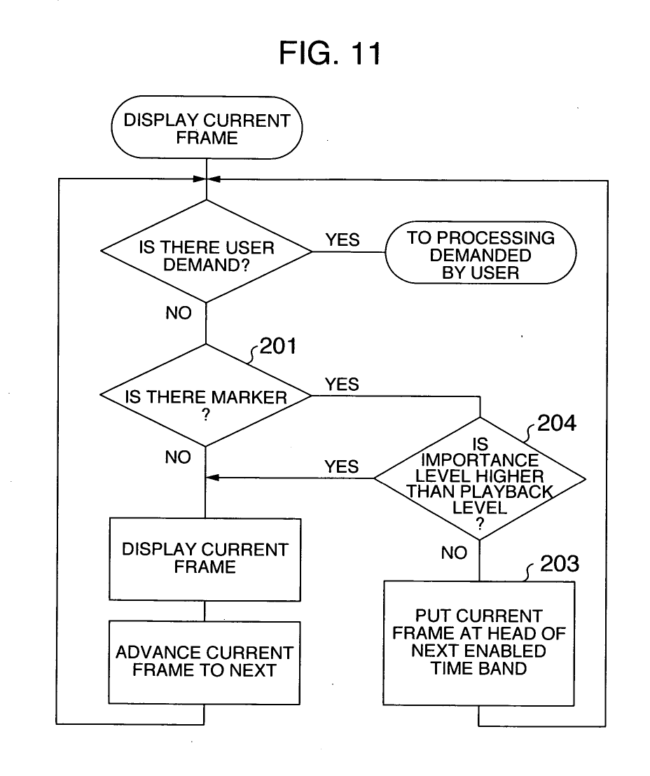

A second embodiment of this invention will be described by referring to FIG. 8, FIG. 9 and FIG. 11.

Based on the summary importance level information 23, the second embodiment assigns each of the time bands one of four levels corresponding to the summary playback time length, in order to find the time bands that need summary playback according to their level. Although this embodiment uses four levels for simplicity, different number of levels may also be used.

FIG. 8 shows a table corresponding to the summary playback information of FIG. 5 for the first embodiment. The summary playback information, as shown in FIG. 8, includes start and end time information and an importance level for each time band.

In the second embodiment a means to hold a playback level is newly added so that the time bands that need to be played back are determined according to the playback level. When a recorded video file is selected, the playback level is determined according to the summary playback time length. During the summary playback, the playback level is selected by the user demand from the remote 3.

FIG. 9 illustrates a schematic view corresponding to FIG. 6A of the first embodiment. The higher the level of importance, the brighter the time band is displayed; and the lower the level of importance, the darker the time band is displayed. Although different importance levels are assigned with different levels of brightness in this embodiment, other means may be used as long as their difference can be distinguished.

In FIG. 9, reference number 64 represents a playback start position, 101 to 117 markers, and 70 a playback end position. In FIG. 9, the brightest time bands are between 103 and 104, between 110 and 111, and between 114 and 115. The second brightest time bands are between 101 and 102, between 104 and 105, between 107 and 108, between 109 and 110, between 111 and 112, and between 115 and 116. The third brightest time bands are between 102 and 103, between 106 and 107, between 112 and 113, and between 116 and 117. The time bands with lowest brightness are between 64 and 101, between 105 and 106, between 108 and 109, between 113 and 114 and between 117 and 70.

Further, reference number 120 represents a playback level newly added in this embodiment and, in FIG. 9, the second brightest level is selected.

During the playback, the time bands with importance levels equal to or higher than the selected playback level are played back.

Therefore, in the example of FIG. 9, the time bands between 101 and 102, between 103 and 105, between 107 and 108, between 109 and 112, and between 114 and 116 are played back.

In the state of FIG. 9, by pressing the up button 50 of the remote 3, lower importance levels can be selected, the playback level indication 120 changed and at the same time the summary playback ratio increased. Similarly, pressing the down button 53 can select only higher importance levels, change the playback level indication 120 and at the same time lower the summary playback ratio.

FIG. 11 shows an outline of processing to display one frame during the summary playback in the second embodiment. What differs from the first embodiment is the processing that is executed when the decision 201 on whether there is a marker is YES. In the first embodiment, the decision as to whether or not to display one frame is made according to the playback enable/disable selection in the summary playback information, whereas the second embodiment makes the decision according to whether or not the importance level is higher than the playback level.

It should be further understood by those skilled in the art that although the foregoing description has been made on embodiments of the invention, the invention is not limited thereto and various changes and modifications may be made without departing from the spirit of the invention and the scope of the appended claims.

1. A video/voice playback device for playing video information and voice information, comprising:
a storage device to record the video information and the voice information;
a summary importance level information recording unit to record an importance level of the video information and of the voice information for each time band;
a summary information generation unit to generate summary playback information from the importance level of the video/voice information for each time band according to a set summary playback time or summary playback ratio;
a playback control unit to read the video information or voice information to be summary-played back, from the storage device based on the summary playback information generated by the summary information generation unit; and
a display unit to display the video information read out for summary playback and to display playback times of the recorded video/voice information in such a manner that those playback times to be summary-played back and those playback times not to be summary-played back are distinguishable.

2. A video/voice playback device according to claim 1, wherein the summary importance level information recording unit records a start time and an end time for each time band and a value of the importance level for the associated time band.

3. A video/voice playback device according to claim 1, wherein the display unit displays the time bands to be summary-played back and the time bands not to be summary-played back in a seek bar format and also displays a cursor representing a playback position in a manner interlocked with the summary playback of the video/voice information.

4. A video/voice playback device according to claim 3, wherein the display unit displays the time bands to be summary-played back in a bright color and the time bands not to be summary-played back in a dark color.

5. A video/voice playback device according to claim 1, further including:
an operation unit to select between the summary playback of the video/voice information and a normal playback of the video/voice information;
wherein, when it receives an instruction of selection of the normal playback from the operation unit during the summary playback of the video/voice information, the playback control unit reads from the instructed summary playback position the video information or voice information of the video/voice information to be played.

6. A video/voice playback device according to claim 5, wherein the operation unit has a fast feed button or a rollback button;
wherein the playback control unit changes the read position by taking the summary playback information as skip mark information, reads the video information or voice information from the storage device and performs the fast feed playback or rollback playback of the video/voice information.

7. A video/voice playback device according to claim 1, wherein the summary information generation unit again generates a summary playback information from the importance level of the video/voice information for each time band according to the summary playback time or summary playback ratio that has been changed by operations of the operation unit;
wherein the display unit updates a content displayed.

8. A video/voice playback device according to claim 1, further including:
a summary playback level holding means;
wherein the summary information generation unit generates summary playback information having a playback level for each time band from the importance level of the video/voice information for each time band;
wherein the playback control unit reads, from among the summary playback information, the video information or voice information in time bands with levels higher than the playback level set in the summary playback level holding means;
wherein the display unit displays the video information read for summary playback and at the same time displays the summary playback information in such a manner that the levels of the time bands are distinguishable.

9. A video/voice playback device according to claim 8, wherein the summary playback level recorded in the summary playback level holding means is changed by operations;
wherein, when the summary playback level is changed, the playback control unit reads, from among the summary playback information, the video information or voice information in time bands with levels higher than the playback level set in the summary playback level holding means;
wherein the display unit displays, according to a change, the video information or voice information read for summary playback and at the same time displays the summary playback information in such a manner that the levels of the time bands are distinguishable.

10. A video/voice playback device for playing video information and voice information, comprising:
a storage device to store the video information and the voice information;
an operation unit to instruct a selection between a summary playback of the video/voice information and a normal playback of the video/voice information;
a seek bar display unit to display playback times of the video information and voice information according to the summary playback selection instruction by the operation unit in such a manner that the playback times to be summary-played back and the playback times not to be summary-played back are distinguishable, the seek bar display unit having a cursor representing a playback position; and
a video display unit to display the video information from the storage device in a manner interlocked with a movement of the cursor on the seek bar display unit.

11. A video/voice playback device according to claim 10, wherein the seek bar display unit has bright color areas representing the portions to be summary-played back and dark color areas representing the portions not to be summary-played back;
wherein a ratio between the bright color areas and the dark color areas is changed by an operation of the operation unit.

12. A video/voice playback device according to claim 11, further including:
a means to set the summary playback time for the video/voice information;
wherein the seek bar display unit changes the ratio between the bright color areas representing the portions to be summary-played back and dark color areas representing the portions not to be summary-played back according to the set summary playback time.

13. A video/voice playback device according to claim 11, further including:
a means to set the summary playback ratio for the video/voice information;
wherein the seek bar display unit changes the ratio between the bright color areas representing the portions to be summary-played back and dark color areas representing the portions not to be summary-played back according to the set summary playback ratio.

14. A video/voice playback device according to claim 10, wherein the seek bar display unit distinguishably displays time bands at a plurality of summary playback levels corresponding to importance levels of the video/voice information;
wherein the video display unit displays video information with importance levels higher than the level set in the operation unit.

15. A video playback method for a video/voice playback device to play video information and voice information, comprising the steps of:
recording importance levels of the video information and voice information for each time band;
generating summary playback information indicating whether the summary playback is enabled or disabled, according to a set summary playback time or summary playback ratio;
displaying a playback enable/disable selection for the video/voice information based on the summary playback information; and
displaying a cursor representing a playback position in a manner interlocked with the summary playback enable/disable indication for the video/voice information.

16. The video playback method according to claim 15, wherein the cursor moves interlocked with the summary playback of the video information when the playback enable/disable selection indication is a playback enable for the video/voice information and skips when the playback enable/disable selection indication for the video/voice information is a playback disable.

17. The video playback method according to claim 15, wherein when an instruction for normal playback of the video/voice information is received, an entire band of a playback enable/disable selection for the video/voice information is displayed as a band with a playback enable selection, and
markers are displayed according to a start time or end time of reserved information.

18. The video playback method according to claim 17, wherein when an instruction for normal playback of the video/voice information is received, the playback is skipped to a previous marker by pressing a back skip button.

19. The video playback method according to claim 15, wherein when a summary playback time or summary playback ratio is changed, summary playback information indicating whether the summary playback is enabled or disabled according to the changed summary playback time or summary playback ratio is generated again.

20. The video playback method according to claim 15, wherein a displaying of a current frame of the video/voice information and a movement of the current frame are controlled by referencing time information and playback enable/disable information in the summary playback information.
